(19) United States
(12) Patent Application Publication
(10) Pub. No.: US 2009/0106033 A1
(43) Pub. Date: Apr. 23, 2009

(54) System and Method for Estimating a Shipment Delivery Date

(76) Inventors: Ashok Thangavelu, Austin, TX (US); Lance C. Smith, Round Rock, TX (US)

Correspondence Address: HAMILTON & TERRILE, LLP, P.O. BOX 203518, AUSTIN, TX, 78720, US

(21) Appl. No.: 11/874,487

(22) Filed: Oct. 18, 2007

(51) Int. Cl. G06Q 10/00; G06F 17/40; G06F 19/00

(52) U.S. Cl. 705/1

(57) ABSTRACT

An estimated delivery date model determines an estimated delivery date for a shipment of a product to a consumer. For example, a built-to-order information handling system shipped through plural shipping providers has an estimated delivery date determined to provide early notice of the shipment to the consumer. The delivery date is estimated from a manifest for the product based on time in transit adjusted for predicted delays, such as in hubs or due to non-shipping days.

### BACKGROUND OF THE INVENTION

1. Field of the Invention

The present invention relates in general to the product shipments to consumers, and more particularly to a system and method for estimating a shipment delivery date.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have tremendous flexibility to adapt to a variety of functions because information handling systems are built from a wide variety of components having a wide range of capabilities. Consumers who desire information handling systems for particular functions often purchase the information handling systems “built-to-order.” An information handling system that is built to order is built based on a configuration of components selected by an end user who purchases the system. For example, a purchaser interacts with a manufacturer through the Internet or a telephone sales representative. The purchaser selects a desired model and then selects components to populate the model, such as the type of processor, amount of memory, storage drives and software components like the operating system and applications. The manufacturer builds the information handling system to the order placed by the purchaser and then ships the information handling system to a destination designated by the manufacturer. The build-to-order process provides an improved purchaser experience by allowing the purchaser to balance the cost of an ordered system with the performance of the system needed by the system. The manufacturer benefits due to the improved purchaser experience plus cost savings from reduced inventory of components and built systems.

One difficulty with the build-to-order process is the shipment of the built information handling system to the correct purchaser at the correct location in a timely manner. In some cases, enterprises who order large numbers of information handling systems arrange for their own shipments using their own shipping contract. In other cases, the information handling system manufacturer will contract with a shipping provider to ship the package to the end user. Typically, shipment of information handling systems requires a signature by a receiving party to verify the delivery. Deliveries to business customers generally do not present a significant challenge since most businesses have a receptionist or other employee on hand to accept delivery. In contrast, delivery to individual consumers at their residences can present a challenge since individual consumers are often not home during normal delivery hours. Unsuccessful delivery attempts increase shipping costs since the shipping provider must redeliver the package at a later date. When numerous delivery attempts are unsuccessful, the package may even be returned to the manufacturer. In some instances, the shipping provider will attempt to contact individuals at residences to arrange to have someone home that can accept the delivery. However, notice to a residence on the day of shipment is often ineffective since the individual does not have time to arrange to stay home. Advanced notice is sometimes difficult since more than one shipping provider may be involved in the shipment process.

### SUMMARY OF THE INVENTION

Therefore a need has arisen for a system and method which estimates a delivery date for a product to give more timely notice to the recipient of the product.

In accordance with the present invention, a system and method are provided which substantially reduce the disadvantages and problems associated with previous methods and systems for estimating a delivery date to a recipient of a product. Information drawn from a product manifest is validated and then applied to predict the day on which a delivery of the product will occur. Shipment is performed to have the product arrive on the estimated delivery date to help ensure that the consumer who ordered the product will be present to receive the product.

More specifically, an information handling system built to order for a consumer is completed at a manufacture facility according to a manifest. Shipping information drawn from the manifest is applied to an estimated delivery date model in order to predict the delivery date for shipment of the product. For example, the actual or requested ship code for the product is taken from the manifest to determine a time in transit for the product. The time in transit is adjusted for a variety of factors, such as delays introduced by hub passage, late arrival at a shipping facility, and non-shipping days. The estimated delivery date is forwarded to shipping provider and the consumer to help coordinate receipt of the product by the consumer.

The present invention provides a number of important technical advantages. One example of an important technical advantage is that an estimated delivery date is determined by application of product manifest information to a delivery model. Computing an estimated delivery date from manifest information allows a manufacturer to manage notice to consumers of the delivery instead of relying on a shipping provider. An estimated delivery date computed at completion of manufacture of a build-to-order product, such as an information handling system, provides greater warning of the delivery to the consumer than actual product tracking so that consumers are more likely to be available when the product is delivered.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for delivery of products with an estimated delivery date;

FIG. 2 depicts a block diagram of system for estimating a product delivery date; and

FIG. 3 depicts a flow diagram of a process for estimating a delivery date of a product.

### DETAILED DESCRIPTION

An estimated delivery date for a built-to-order information handling system provides a consumer with advanced notice of the delivery of the system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

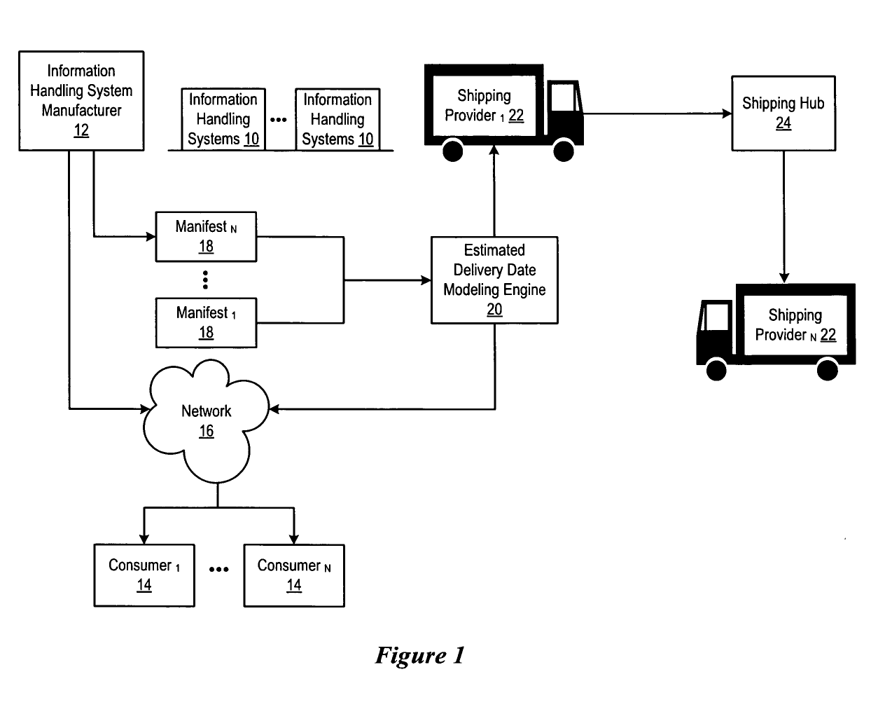

Referring now to FIG. 1, a block diagram depicts a system for delivery of products with an estimated delivery date. In the example embodiment, information handling systems 10 are built to order by an information handling system manufacturer 12 based on orders placed by consumers 14. For example, consumers 14 place orders through a network 16, such as the Internet or POTS, with order specifying a configuration selected by the consumer 14. As the orders are built, a manifest 18 issues with the information handling system 10 that specifies the configuration of the information handling system 10 and the delivery address as requested by the consumer 14. Each manifest 18 is provided to an estimated delivery date modeling engine 20 so that an estimated delivery is determined for the information handling system 10 associated with that manifest. The estimated delivery date modeling engine outputs an estimated delivery date that accounts for a variety of factors, such as plural different shipping providers 22 and routing through one or more shipping hubs 24. Notice to the consumer 14 of the estimated delivery date for the information handling system 10 provides the consumer with an improved opportunity for being present at delivery.

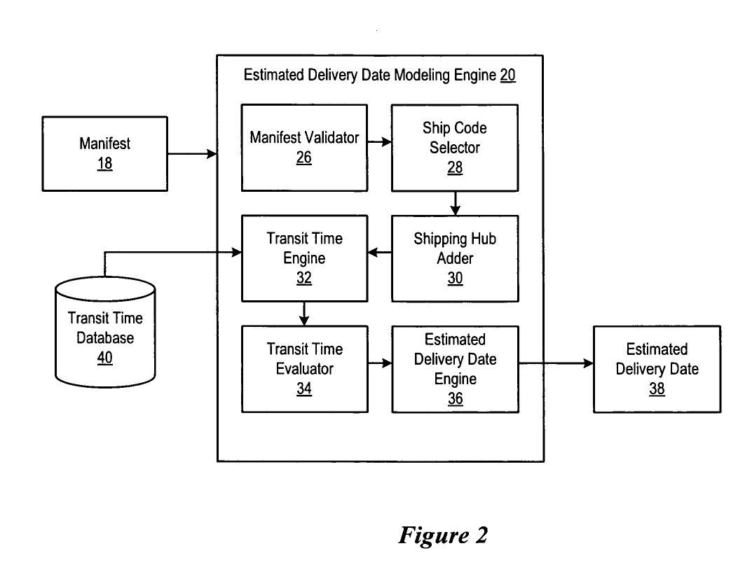

Referring now to FIG. 2, a block diagram depicts a system for estimating a product delivery date. An estimated delivery date modeling engine 20 receives a manifest 18 for the product of interest and outputs an estimated delivery date 38 so that a notification of the delivery date is sent to the consumer when the product is shipped. A manifest validator 26 inspects the manifest 18 to determine if sufficient information exists to estimate a delivery date, such as by review of required fields in manifest 18. The fields within manifest 18 include a requested ship code that represents the service level requested by the consumer, the actual ship code that identifies a selected carrier and type of shipment, a source carrier ID, a source facility ID that identifies the facility from which the shipment occurs, the destination zip code and the ship date and time that represents the time that the product reached a ship complete status in the facility. If insufficient data exists to validate the manifest, then an error message issues. Valid manifest information proceeds to a ship code selector 28 that validates that the actual ship code is recognized. If the actual ship code exists, then it is used to identify the shipping provider's service level. If the actual ship code does not exist, then the requested ship code is used instead of the actual ship code. After selection of the ship code, the manifest information proceeds to a shipping hub adder 30 that determines if the selected ship code will bring the product through a hub and, if so, the delay added by passage through the hub.

Once the manifest information is validated, the ship code selected and the hub passage is confirmed, a transit time engine 32 determines a transit time associated with shipment of the product. For example, if an actual ship code is selected, transit time engine 32 assigns a value based on the service level associated with the ship code. If plural shipping providers are involved in the shipment, such as a truckload shipper and a parcel shipper or a less than truckload shipper and a parcel shipper, the time for each is added based on the service level for each. If a requested ship code is selected, a look-up is performed in transit time database 40 to retrieve the transit time associated with the requested ship code. In alternative embodiments, other factors may be considered in determining the transit times for actual and requested ship codes, such as models that consider the impact of weather on each shipping provider or historical shipping results associated with each shipping provider. The transit time determined by transit time engine 32 is forwarded to a transit time evaluator 34 that evaluates the determined transit time for accuracy. For example, transit time evaluator 34 determines if a day during the transit falls on a facility or shipping provider holiday or other non-shipping day. Transit time evaluator 34 also determines whether the product is completed in time to ship on its completion date or if another day is needed. An estimated delivery date engine 36 completes calculation of an estimated delivery date 38 by adding transit time for the service level of the shipping code with additional days for hub passage and non-shipping days. The estimated delivery date 38 is forwarded to the consumer to allow preparation for receipt of the product.

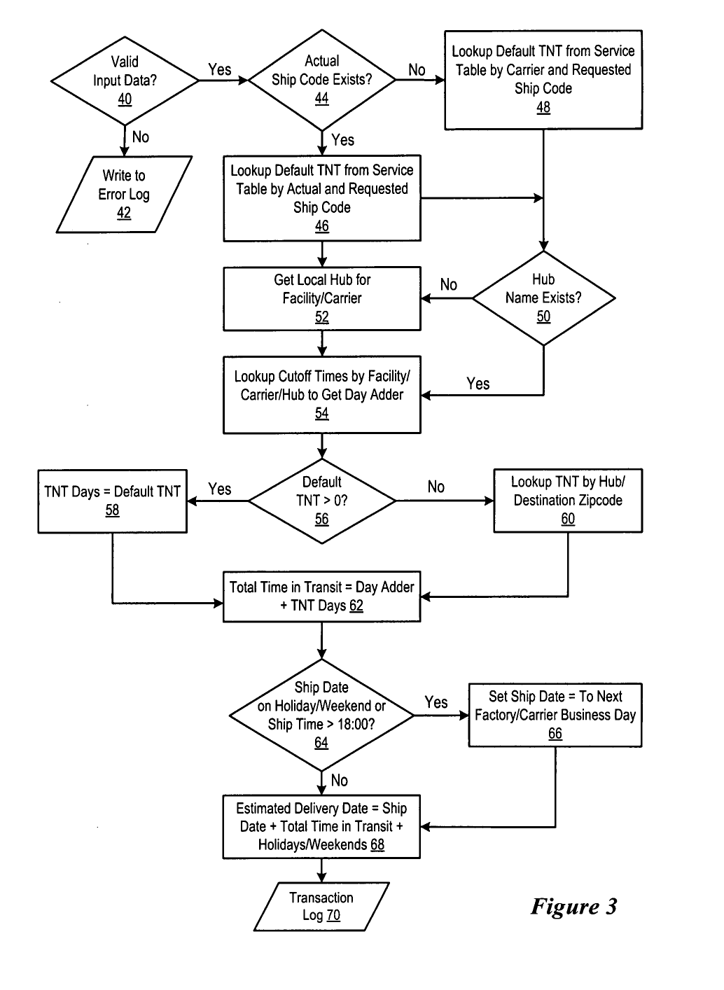

Referring now to FIG. 3, a flow diagram depicts a process for estimating a delivery date of a product. The process begins at step 40 with validation of the manifest input information to confirm that sufficient information is available to estimate a delivery date. If the manifest information is not sufficient, the process continues to step 42 to write an error. If the manifest information is sufficient, the process continues to step 44 to determine whether an actual ship code exists. If an actual ship code exists, the process continues to step 46 to lookup the default time in transit from service tables for each shipping provider associated with the shipment by both the actual and requested ship codes. If no actual ship exists, the process continues to step 48 to lookup the default transit times for just the requested ship code. At step 50, a determination is made of whether one or more shipping hubs are involved in the shipment. For each hub involved in the shipment, transit time is added for the time associated with progress through the hub, such as based upon the time of day the shipment is expected to arrive at the hub. If, at step 50, a hub is not named, the process continues to step 52 to determine the local hub for the facility of the shipment and the shipping providers involved. If, at step 50, a hub is named, the process continues to step 54 to lookup cutoff times by facility and shipping provider to each hub to determine a number of days to add for progress through the hubs.

At step 56, a determination is made of whether the value of a default transit time is greater than zero. For example, the default transit time is set at zero and changed to a value for transit time based on the lookup at steps 46 and 48. If the default transit time is greater than zero, then the process continues to step 58 to assign the transit time value as the default value. If the default transit time remains at zero, then the process continues to step 60 to lookup a transit time based upon the shipping providers, hub and destination zip code. At step 62, a total time in transit is determined by adding the transit time with additional days associated with hub passage. At step 64, an evaluation is made of the shipping date and time to determine if additional time is added to the total transit time to account for a late departure from the shipping facility or shipment that will occur over a weekend or holiday. If the evaluation suggests that extra days will be added, the process continues to step 66 to set the shipping date as the time that the product is predicted to leave the shipping facility and to determine a number of non-shipping days to add to the total time in transit. At step 68, the estimated delivery date is determined by adding to the shipping date the total time in transit to the days that involve non-shipment. At step 70, the estimated delivery date is placed in a transaction log to forward to the consumer so that the consumer can plan on receipt of the shipped product.

Although the present invention has been described in detail, it should be understood that various changes, substitutions and alterations can be made hereto without departing from the spirit and scope of the invention as defined by the appended claims.

What is claimed is:

1. A method for estimating the delivery date of a product shipped from a manufacturer to a consumer, the method comprising:
extracting predetermined information from a manifest associated with the product;
applying the predetermined information to determine a transit time for the product;
adjusting the transit time for one or more predetermined factors to determine an estimated delivery date; and
shipping the product to arrive at the consumer on the estimated delivery date.

2. The method of claim 1 wherein extracting the predetermined information further comprises extracting plural shipping providers from the manifest, each shipping provider scheduled to ship the product at least part of the way to the consumer.

3. The method of claim 1 wherein extracting the predetermined information further comprises extracting a ship code and destination zip code.

4. The method of claim 3 further comprising:
determining an invalid ship code; and
assigning a requested ship code to determine the transit time.

5. The method of claim 1 wherein adjusting the transit time further comprises adding to the transit time for shipping through a shipment hub.

6. The method of claim 1 wherein adjusting the transit time further comprises adding to the transit time for non-shipping days.

7. The method of claim 1 further comprising notifying the customer of the estimated delivery date on the day the product is shipped.

8. The method of claim 7 wherein the product comprises a built-to-order information handling system.

9. A system for estimating a delivery date for a product to a consumer, the system comprising:
a manifest validator operable to receive a manifest for the product, to extract predetermined information from the manifest and to validate that the extracted information will support estimation of a delivery date of the product;
a transit time engine interfaced with the manifest validator and operable to apply the predetermined information to determine estimated time in transit for the product; and
an estimated delivery date engine interfaced with the transit time engine and operable to adjust the transit time to determine an estimated delivery date.

10. The system of claim 9 wherein the extracted information comprises plural shipping providers.

11. The system of claim 10 wherein the shipping providers comprise at least a parcel shipper.

12. The system of claim 11 wherein the shipping providers comprise at least a less than truckload shipper.

13. The system of claim 11 wherein the shipping providers comprise at least a truckload shipper.

14. The system of claim 13 wherein the product comprises an information handling system.

15. The system of claim 9 wherein the estimated delivery date engine adjusts the transit time by adding non-shipping days to the transit time to determine the estimated delivery date.

16. The system of claim of claim 9 wherein the manifest validator is further operable to determine that the extracted information will not support estimation of a delivery date and to substitute valid information for the extracted information.

17. The system of claim 16 wherein the manifest validator substitutes a manifest ship code with a requested ship code associated with the product.

18. A method for estimating an information handling system delivery date, the method comprising:
retrieving time in transit information;
estimating hub time associated with transit through one or more hubs;
estimating non-shipping days;
adding the time in transit, hub time and non-shipping days to determine a total time in transit;
adding the total time in transit to information handling system manufacture date to determine the estimated delivery date.

19. The method of claim 18 wherein retrieving time in transit information further comprises retrieving time in transit for plural shipping providers associated with delivery of the information handling system.

20. The method of claim 18 wherein retrieving time in transit information comprises:
looking up time in transit information for an actual ship code associated with the information handling system; and
looking up time in transit for a requested ship if no valid actual ship code is found.
